(19) United States
(12) Patent Application Publication
(10) Pub. No.: US 2014/0169803 A1
(43) Pub. Date: Jun. 19, 2014

(54) PRINTER APPARATUS AND SECURITY METHOD USED FOR THE SAME

(71) Applicant: Ike Seung Ho LEE, Montrose, CA (US)

(72) Inventor: Ike Seung Ho LEE, Montrose, CA (US)

(21) Appl. No.: 13/713,524

(22) Filed: Dec. 13, 2012

(51) Int. Cl. G03G 15/00

(52) U.S. Cl. CPC G03G 15/553
USPC 399/12

(57) ABSTRACT

The present invention relates to a printer apparatus and a security method used for the same. The present invention can store a plurality of printer security algorithms in a printer, and stores a plurality of toner security algorithms corresponding to the respective printer security algorithms, and can replace security algorithms that are applied to the printer and toner either periodically or at an arbitrary time.

### BACKGROUND OF THE INVENTION

1. Field of the Invention

The present invention relates, in general, to a printer apparatus and a security method used for the apparatus and, more particularly, to a printer apparatus that is composed of a printer host and toner, having replaceable security algorithms, and a security method used for the printer apparatus.

2. Description of the Related Art

In order to print documents stored in a computer, printer apparatuses are used. Such a printer apparatus is implemented as an independent device composed of a printer and toner (also referred to as a ‘toner cartridge’) or, in a more complicated form, as a scheme in which the printer is connected to a communication network. Manufacturers that supply printers produce toner suitable for the corresponding printer in their own manufacturing plants, and supply the produced toner to consumers. However, since the toner supplied by the manufacturers is typically expensive, recycled toner has appeared on the market.

Printer manufacturers have made various attempts to prevent the use of recycled toner, but satisfactory results have not yet been achieved. Initial technology for ensuring that authentic toner is used is to design the shape of toner in conformity with a host. However, this method is problematic in that it is not greatly effective because the shape of toner can be easily analyzed and duplicated.

Further, methods of authenticating toner using CryptoMemory of Atmel for a printer and toner have been applied to printers. This authentication technology adopts a method in which after a symmetrical master key used to authenticate a printer has been stored in flash memory separately from a Central Processing Unit (CPU), if toner (a toner cartridge) equipped with CryptoMemory for storing an authentication key generated from the master key is mounted in the printer, the printer obtains the authentication key stored in the CryptoMemory of the toner via Inter-Integrated Circuit (I2C) communication and authenticates the toner. However, such authentication technology is problematic in that flash memory mounted in the printer is implemented as an independent product, so that a master key that is stored can be detected via a memory dump in flash memory. Further, if the master key is leaked, the security of all printers of the same model is compromised. The length of the master key is as small as 64 bits, and thus it would be possible to relatively easily duplicate the master key.

In order to solve this problem, Patent document 1 provides a printer apparatus to which a cryptography security scheme using a public key is applied. When such a complicated security scheme is applied, some additional time may be further required for a third manufacturer, other than a printer manufacturer, to manufacture recycled toner, but there still remains a problem in that the toner can be relatively easily duplicated.

### SUMMARY OF THE INVENTION

Accordingly, the present invention has been made keeping in mind the above problems occurring in the prior art, and an object of the present invention is to provide a printer apparatus, which adopts a security method to prevent a recycled toner manufacturer from easily producing authentic toner products.

Another object of the present invention is to provide a printer apparatus, which has a toner operation method that identifies toner cartridges, mounted in a printer, for respective toner classes, and that enables a printer manufacturer to control whether the corresponding toner cartridge is usable for respective classes.

In order to accomplish the above objects, the present invention provides a printer apparatus, the printer apparatus including a printer for encrypting and providing an externally received document using a printer security algorithm, and a toner cartridge for decrypting and providing the encrypted document using a toner security algorithm, wherein the printer includes writable non-volatile memory for storing a plurality of printer security algorithms and storing a plurality of key values applicable to the respective printer security algorithms and an encryption module for encrypting the document using one selected from among the plurality of printer security algorithms and providing an encrypted document to the toner cartridge, and the toner cartridge comprises writable non-volatile memory for storing a plurality of toner algorithms corresponding to the plurality of printer security algorithms and a plurality of key values applicable to the respective toner security algorithms, and a decryption module for decrypting the encrypted document using one selected from among the plurality of toner security algorithms.

Further, in order to accomplish the above objects, the present invention provides a printer apparatus which classifies toner cartridges that can be mounted in respective printers and stores the classified toner cartridges in a toner DB, and which stores the classes of toner cartridges mounted in the printer.

Additional aspects and/or advantages of the invention will be set forth in part in the description which follows and, in part, will be obvious from the description, or may be learned by practice of the invention.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram showing a printer system according to an embodiment of the present invention;

FIGS. 2A and 2B are flow diagrams showing a method of performing printing using double security among a plurality of security algorithms;

FIGS. 3A and 3B are diagrams showing the configuration of an MCU provided in a printer and an MCU provided in a toner cartridge according to an embodiment of the present invention;

FIG. 4 is a flow diagram showing operations performed by the printer system when an event, such as the replacement of a toner cartridge, occurs;

FIG. 5 is a flow diagram showing operations performed by the printer system when an event, such as the replacement of a toner cartridge, occurs, and an internal computer is not connected to a management server over a communication network;

FIG. 6 is a flow diagram showing operations performed when an event for requesting the change of a security algorithm or key values is processed by the printer system according to the present invention; and

FIG. 7 is a flow diagram showing operations performed when a new algorithm is applied to the printer system according to the present invention.

FIG. 8 is a flowchart showing the conventional processing flow of security information between printer MCU and toner MCU.

FIG. 9 is a flowchart showing the proposed processing flow of security information between printer MCU and toner MCU according to the present invention.

FIG. 10 is a diagram showing the proposed processing flow of security information between printer MCU and toner MCU in FIG. 9 in terms of system configuration.

### DETAILED DESCRIPTION OF THE EMBODIMENTS

Hereinafter, embodiments, advantages and features of the present invention will be described in detail with reference to the attached drawings.

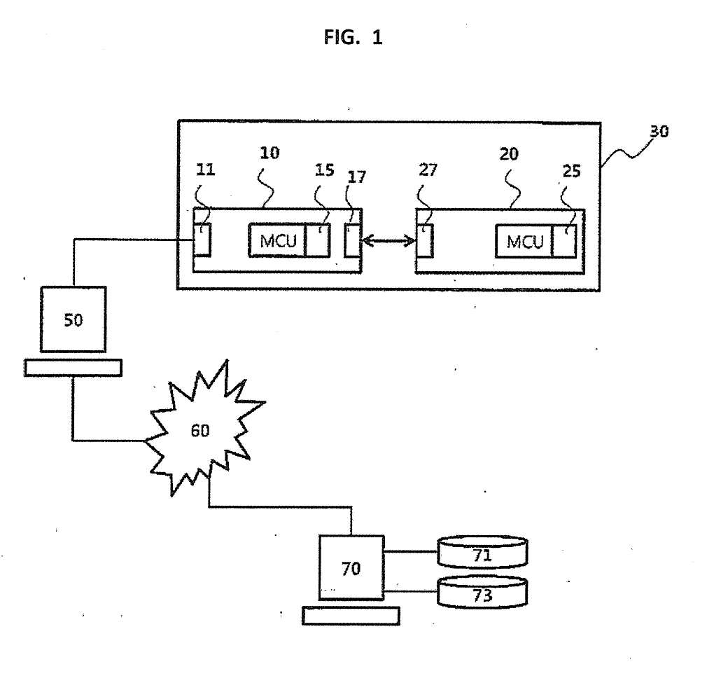

FIG. 1 is a configuration diagram showing a printer system according to an embodiment of the present invention. As shown in FIG. 1, the printer system according to the present invention includes a printer apparatus 30 composed of a printer 10 and a toner cartridge (or toner) 20, an internal computer 50 connected to the printer apparatus 30 over a communication network including the intranet, and a management server 70 connected to the internal computer 50 over a communication network including the Internet. The printer 10 includes therein a Micro Controller Unit (MCU) having writable non-volatile memory 15, a first interface 11 connected to the internal computer, and a second interface 17 connected to the toner cartridge 20. The toner cartridge 20 includes therein an MCU having writable non-volatile memory 25, and a third interface 27 connected to the printer 10. A representative example of the writable non-volatile memory 15 and 25 may include, but is not limited to, flash memory. Further, the processor of the present invention is specified as the MCU, but is not limited thereto and should be understood to denote a control unit including a Central Processing Unit (CPU) or the like. It is known that the printer 10 and the toner cartridge 20 perform Inter-Integrated Circuit (I2C) communication via the second interface 17 and the third interface 27, respectively. However, it is apparent that the communication scheme of the present invention is not limited to I2C communication and various communication schemes can be used. The internal computer 50 is implemented as a typical personal computer or the like having input/output (I/O) devices, and denotes a computer requesting an output command while transferring document data to the printer 10. The management server 70 is indirectly connected to the printer apparatus 30 over the Internet 60 via the internal computer 50 or is directly connected to the printer apparatus 30 over the Internet 60. The management server 70 is provided with a toner database (DB) 71 for classifying and storing the classes of toner cartridges mounted in respective printers, and an algorithm DB 73 for storing printer security algorithms, toner algorithms, and key values that are usable for respective printers and toner cartridges.

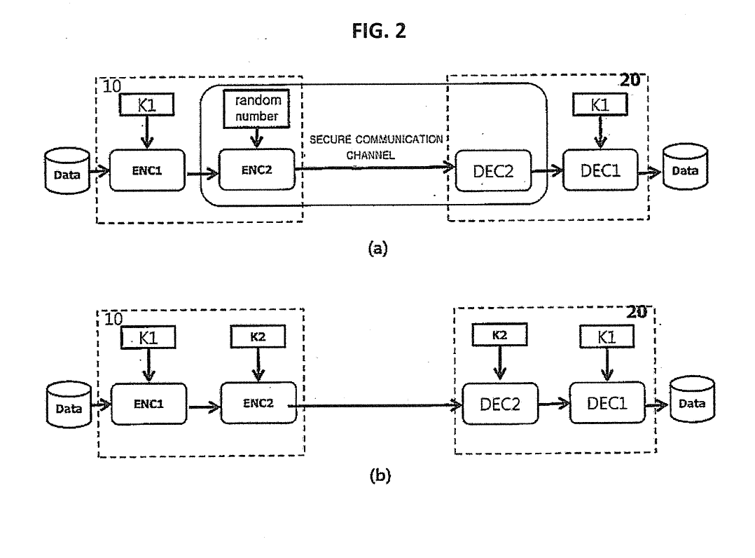

When data desired to be printed is requested via the internal computer 50, the printer 10 according to the present invention encrypts the input data and transmits the encrypted data to the toner cartridge 20. The toner cartridge 20 according to the present invention decrypts the encrypted data and prints the decrypted data. FIGS. 2A and 2B are flow diagrams showing a method of performing printing using double security among a plurality of security algorithms. FIG. 2A illustrates a scheme for processing one of the double security algorithms using a secure communication channel. When data desired to be printed is input, the printer 10 performs encryption (ENC 1) using a key value K1, and performs second encryption (ENC 2) using a random number. When the encrypted data is transmitted to the toner cartridge 20 via a secure communication channel, the toner cartridge performs second decryption (DEC 2) using a random number and performs first decryption (DEC 1) using the stored key value K1 to decrypt the data, and thereafter performs printing. FIG. 2B illustrates a scheme in which double security is performed using two key values K1 and K2. When data desired to be printed is input, the printer 10 performs first encryption (ENC 1) using a first key value K1, and then performs second encryption (ENC 2) using a second key value K2. When the encrypted data is transmitted to the toner cartridge 20, the toner cartridge performs second decryption (DEC 2) using the stored second key value K2 and performs first decryption (DEC 1) using the stored first key value K1 to decrypt data, and then performs printing.

In this case, when the secure communication channel shown in FIG. 2A is used, key values for random numbers are shared and used, so that only the key value K1 must be stored in both the printer 10 and the toner cartridge 20. In contrast, in the case of FIG. 2B, the key values K1 and K2 must be stored in both the printer 10 and the toner cartridge 20.

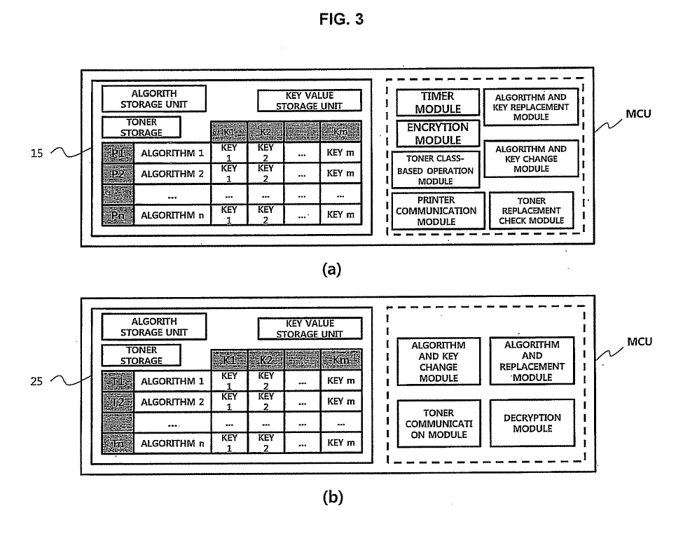

Each of the printer 10 and the toner cartridge 20 according to the present invention is configured to store a plurality of security algorithms and a plurality of key values used for respective algorithms. The plurality of security algorithms and the plurality of key values can be periodically changed by the printer 10 or can be changed at a desired time in compliance with a command from the management server 70 presented in FIG. 1. FIGS. 3A and 3B are diagrams showing the configuration of the MCU provided in the printer and the MCU provided in the toner cartridge according to an embodiment of the present invention. First, the case of FIG. 3A will be described below. The writable non-volatile memory 15 provided in the MCU of the printer 10 is configured such that a plurality of printer security algorithms P1, P2, . . . , Pn, key values K1, K2, . . . , Km usable for respective printer security algorithms, and printer security algorithm identifiers required to identify a printer security algorithm that is currently being used are stored in an algorithm storage unit, and such that key values that are currently being used are stored in a key value storage unit, and information about the class of a currently mounted toner cartridge is stored in a toner storage unit. In the MCU of the printer 10, functional modules for performing a plurality of functions are provided. As representative functional modules required to perform the present invention, a timer module, an algorithm and key change module, an algorithm and key replacement module, printer communication engine module and an encryption module are provided. The timer module is a module for generating an event signal required to periodically change security algorithms P1, P2, . . . , Pn and key values K1, K2, . . . , Km applied to the printer, and security algorithms T1, T2, . . . , Tn and key values K1, K2, . . . , Km applied to the toner cartridge. For example, when time is set by the timer module at intervals of three days, an event signal required to change the security algorithms P1, P2, . . . , Pn and the key values K1, K2, . . . , Km applied to the printer and the security algorithms T1, T2, . . . , Tn and the key values K1, K2, . . . , Km applied to the toner cartridge, is generated every three days. When such a timer event signal is input, the algorithm and key change module changes a security algorithm and key values that are currently being used in the printer 10 to another security algorithm and other key values, and transmits a toner algorithm and key values corresponding to the changed printer algorithm and key values to the toner cartridge 20. Such changes can be performed by changing identifiers stored in the algorithm storage unit and the key value storage unit provided in the printer 10. The algorithm and key replacement module is a module functioning to download new algorithms and new keys from the management server 70 and replace algorithms and key values stored in the memory with the new algorithms and the new key values. For example, when a new printer algorithm P7′, a new toner algorithm T7′, and key values K′1, K′2, . . . , K′m are transmitted from the management server 70, they are downloaded, one of the printer algorithms stored in the memory is deleted, and the newly downloaded printer algorithm P7′, and key values K′1, K′2, . . . , K′m are stored in the space previously occupied by the deleted algorithm. The identifier of the newly downloaded printer algorithm and key values are stored in the algorithm storage unit and the key value storage unit, respectively. The encryption module is a module for encrypting the data received from the internal computer 50 using the corresponding printer algorithm and the corresponding key values with reference to the values stored in the algorithm storage unit and the key value storage unit.

Next, the case of FIG. 3B will be described. The writable non-volatile memory 25 provided in the MCU of the toner cartridge 20 is configured such that a plurality of toner security algorithms T1, T2, . . . , Tn, key values K1, K2, . . . , Km usable for respective toner security algorithms, and toner algorithm identifiers required to identify a security toner algorithm that is currently being used are stored in an algorithm storage unit, and such that key values that are currently being used are stored in a key value storage unit, and information about the class of a currently mounted toner cartridge is stored in a toner storage unit. The MCU of the toner cartridge 20 is provided with functional modules for performing a plurality of functions. As representative functional modules required to perform the present invention, an algorithm and key change module, an algorithm and key replacement module, toner communication engine module, and a decryption module are provided. The algorithm and key change module changes identifiers stored in the algorithm storage unit and the key value storage unit provided in the toner cartridge 20 in response to a control signal received from the printer 10, commanding that a toner security algorithm and key values that are currently being used should be changed to another toner security algorithm and other key values. The algorithm and key replacement module is a module functioning to download a new toner algorithm and new key values from the management server 70, and replace the toner algorithm and the key values stored in the memory with the new toner algorithm and the new key values. For example, when a new toner algorithm T7′ and new key values K′1, K′2, . . . , K′m are transmitted from the management server 70 through the printer 10, the toner cartridge downloads the new toner algorithm and the new key values, deletes one of the toner algorithms stored in the memory, stores the newly downloaded printer algorithm T7′ and the key values K′1, K′2, . . . , K′m in the space previously occupied by the deleted algorithm, and stores the identifier of the newly downloaded toner algorithm and key values in the algorithm storage unit and the key value storage unit, respectively. The decryption module is a module for decrypting the encrypted data received from the printer 10 using the corresponding toner algorithm and key values with reference to the values stored in the algorithm storage unit and the key value storage unit.

Each of aforementioned functional modules in printer and toner can be implemented in hardware or software to implement.

A toner class-based operation module is a functional block for determining toner usage policies depending on the classes of toner cartridges mounted in the printer. For example, a description will be made on the assumption that a toner cartridge directly manufactured by a printer manufacturer is classified as class A, a toner cartridge satisfying a predetermined quality standard, such as by using an approved MCU under a legal agreement with the printer manufacturer even if the toner cartridge is not manufactured by the printer manufacturer, is classified as class B, and the remaining toner cartridges other than classes A and B are classified as class C. Examples of policies managed by the toner class-based operation module allow toner cartridges classified as class A and class B to be normally used, and prevent toner cartridges classified as class C from being used. In this case, the toner class-based operation module is a module for performing management such that the printer is deactivated to prevent a toner cartridge classified as class C from being used in the corresponding printer and such that a message window commanding that an authentic toner cartridge be used is displayed on a display window provided on the printer. A toner replacement check module is a module for checking whether an event, such as the replacement of the toner cartridge 20 mounted in the printer 10 or the re-booting of the printer, has occurred.

Printer communication engine module and toner communication engine module are the communication module to handle data which are received or transmitted through the second interface and the third interface.

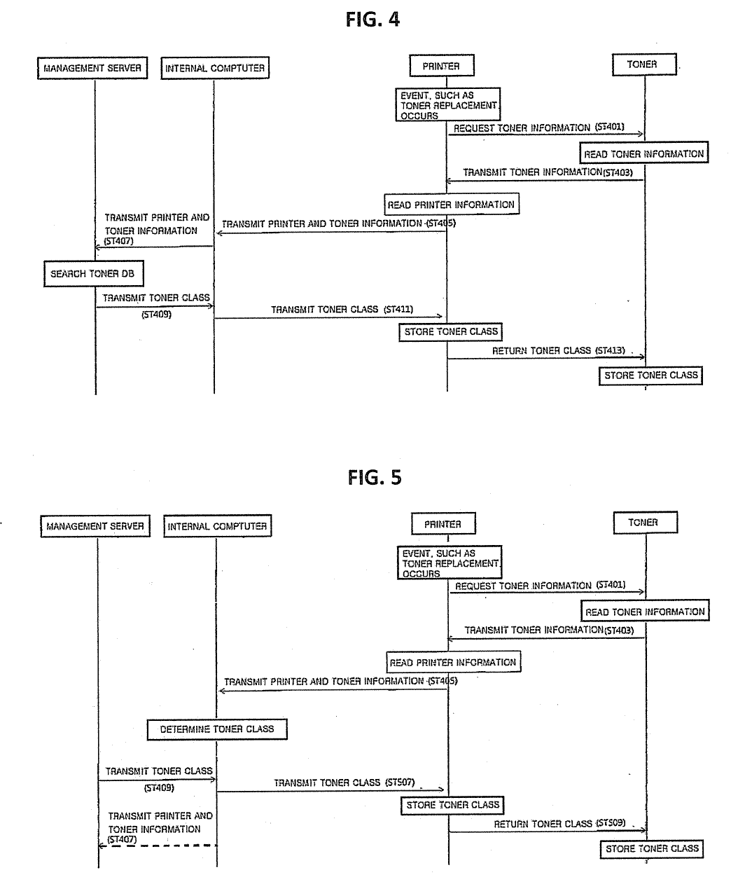

FIG. 4 is a flow diagram showing operations performed by the printer system when an event, such as the replacement of a toner cartridge, occurs. If the occurrence of an event, such as the replacement of a toner cartridge or the re-booting of the printer, has been checked by the toner replacement check module provided in the MCU of the printer 10, the printer requests toner information from the toner cartridge at step ST401. The toner cartridge reads toner information. In this case, the read toner information may include a toner algorithm identifier and key values currently being used, which are stored in the algorithm storage unit and in the key value storage unit of the toner cartridge, toner manufacturer information, toner product information (a serial number or the like), a charged state (or the level of charge), and watermark information (new use or reuse). Here, the read information is referred to as ‘toner information A’. The read toner information A is transmitted to the printer at step ST403. The printer reads printer information, including a printer manufacturer, a printer model name, a serial number, etc., and transmits the read toner information A and printer information to the internal computer at step ST405. When the internal computer is connected to the management server via a communication network, the internal computer transmits the printer information and the toner information A to the management server at step ST407. The management server searches the toner DB 71 to determine whether toner information A corresponding to the received printer information is present in the toner DB 71. In the toner DB 71, information about toner cartridges usable for respective printers is stored, and information about the respective toner cartridges is stored so that the classes thereof are indicated. As described above, examples of the classes include a scheme in which a toner cartridge directly manufactured by a printer manufacturer is classified as class A, a toner cartridge satisfying a predetermined quality standard, such as by using an approved MCU under an agreement with the printer manufacturer even if the toner cartridge is not manufactured by the printer manufacturer, is classified as class B, and the remaining toner cartridges other than classes A and B are classified as class C. In the construction of such a toner DB, classes A and B respectively correspond to a toner cartridge directly manufactured by the printer manufacturer and a toner cartridge manufactured under an agreement, so that a manual operation can be performed in advance. If a toner cartridge matching the received toner information A is present in the toner DB 71, the class of the corresponding toner cartridge is searched for, whereas if a toner cartridge matching the received toner information A is not present in the toner DB 71, the toner information A is collectively used, the corresponding toner cartridge is classified as class B or C, and then the toner DB is updated. The management server transmits the class of the toner cartridge to the printer via the internal computer at steps ST409 and ST411. The printer records the class of the toner cartridge in the toner storage unit, and returns the results of recording to the toner cartridge at step ST413. The printer stores the received toner cartridge class in the toner storage unit.

FIG. 5 is a flow diagram showing operations performed by the printer system when an event, such as the replacement of a toner cartridge, occurs, and the internal computer is not connected to the management server over a communication network. Steps ranging from the occurrence of an event, such as the replacement of a toner cartridge, to step ST405 at which the printer information and toner information A are transmitted to the internal computer are performed in the same manner as that of FIG. 4. In this case, since the internal computer is not connected to the communication network, it cannot access the management server. Therefore, the class of the toner cartridge is determined by activating a toner class-based operation module stored in the internal computer. Thereafter, the determined toner cartridge class is transmitted to the printer at step ST507. The printer records the toner cartridge class in the toner storage unit, and returns the results of recording to the toner cartridge at step ST509. The printer stores the received toner cartridge class in the toner storage unit. Thereafter, when the communication network is recovered and the internal computer is connected to the management server, a procedure starting from step ST407 at which the printer information and toner information are transmitted to the management server is performed again and the subsequent steps are performed, as shown in FIG. 4. That is, when the internal computer is not connected to the management server due to the interruption of the communication network, a method is used in which the internal computer temporarily determines the class of a toner cartridge and in which the class of the toner cartridge is normally determined if the communication network has been recovered and has been connected to the management server.

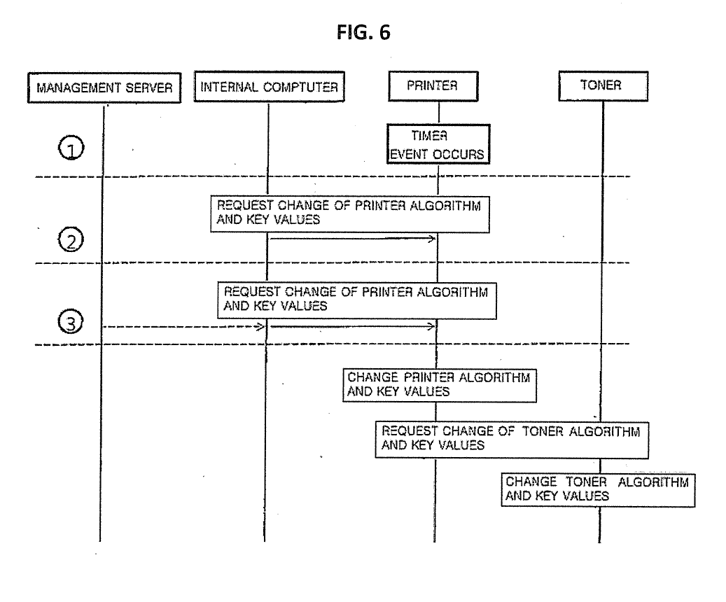

FIG. 6 is a flow diagram showing operations performed when an event for requesting the change of a security algorithm or key values is processed by the printer system according to the present invention. The change of a security algorithm or key values include a case where an event triggered by a timer provided in the printer occurs (\textcircled{1}), a case where a request is received from the internal computer (\textcircled{2}), and a case where a request is received from the management server (\textcircled{3}). When such a request is received, the printer changes a printer algorithm identifier stored in the algorithm storage unit and changes current key values stored in the key value storage unit by using the algorithm and key change module. Thereafter, the printer requests the change of a toner algorithm and key values corresponding to a toner cartridge, and the toner cartridge changes a toner algorithm identifier stored in the algorithm storage unit, and changes current key values stored in the key value storage unit. In FIG. 6, although a description has been made such that a security algorithm and key values are simultaneously changed, it is apparent that only the change of key values or only the change of a security algorithm can be separately required.

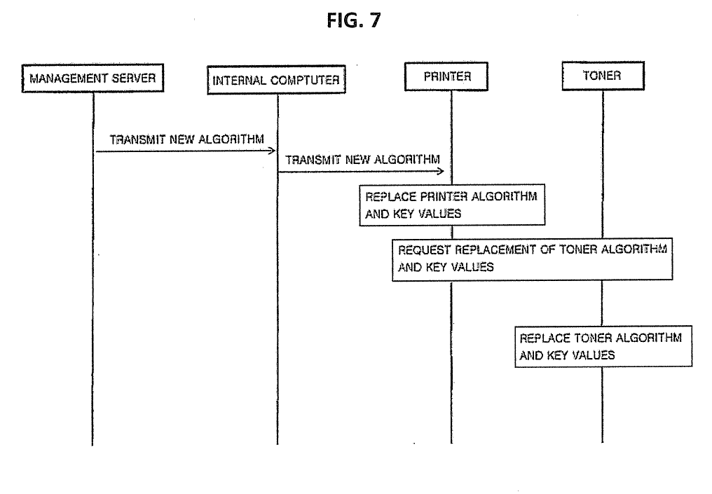

FIG. 7 is a flow diagram showing operations performed when a new algorithm is applied to the printer system according to the present invention. When a new security algorithm is developed, a management server transmits the new algorithm and related key values to a printer through an internal computer. The printer deletes an existing printer algorithm using an algorithm and key replacement module, and stores a newly downloaded printer algorithm. Thereafter, the printer stores a printer algorithm identifier for the newly downloaded printer algorithm in an algorithm storage unit, and stores corresponding key values in a key value storage unit. Next, when the printer requests the replacement of a toner algorithm and key values from a toner cartridge, the toner cartridge deletes an existing toner algorithm and stores a newly downloaded toner algorithm by using the algorithm and key replacement module. Thereafter, a printer algorithm identifier for the newly downloaded printer algorithm is stored in the algorithm storage unit, and the corresponding key values are stored in the key value storage unit.

As described above, the printer apparatus according to the present invention can replace security algorithms stored in a printer and a toner cartridge either periodically or non-regularly, so that when information indicating that a recycled toner manufacturer manufactured recycled toner by duplicating any one algorithm is received, an applied security algorithm can be easily replaced, thus preventing the manufacturer from manufacturing recycled toner any more, or causing an excessively long time to be required to duplicate the algorithm.

Further, the printer apparatus and the security method used for the printer apparatus according to the present invention are advantageous in that control can be performed such that even toner (a toner cartridge) that has not been directly manufactured by a printer manufacturer is enabled to be used for the corresponding printer or is disabled from being used via the classification of classes, thus enabling recycled toner markets to be legalized and the distribution process of recycled toner to be analyzed.

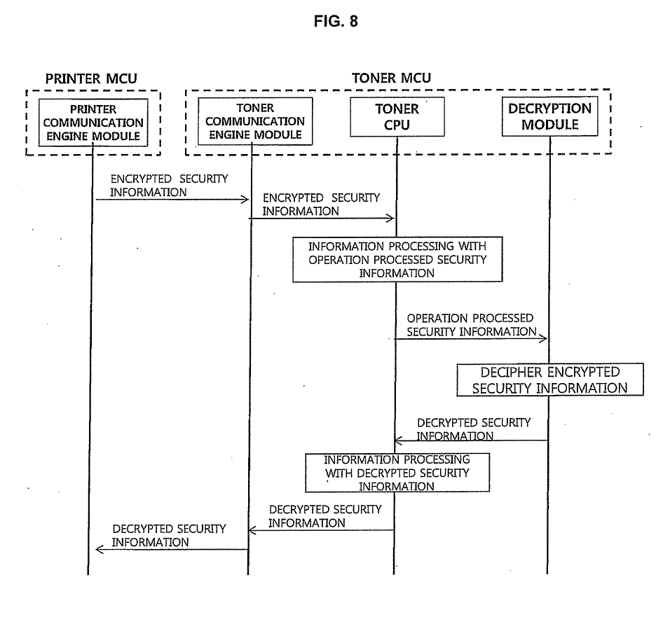

FIG. 8 is a flowchart showing the conventional processing flow of security information between printer MCU and toner MCU. Hereafter, for the convenience of description, only printer communication engine module is drawn in printer MCU and toner communication engine module, decryption module and toner CPU are drawn in toner MCU. Data communication between only functional modules shown in FIG. 8 will be described. Printer communication engine module transmits encrypted security information to toner engine module. And toner engine module transmits encrypted security information to toner CPU. After encrypted security information is operation processed using ALU in Toner CPU, operation processed encrypted security information is transmitted to decryption module. Decryption module deciphers encrypted security information using one of plural toner security algorithm and transmits decrypted security information to toner CPU. After decrypted security information is operation processed using ALU in Toner CPU, decrypted security information is transmitted to toner communication engine module. Finally, decrypted security information is transmitted to printer MCU.

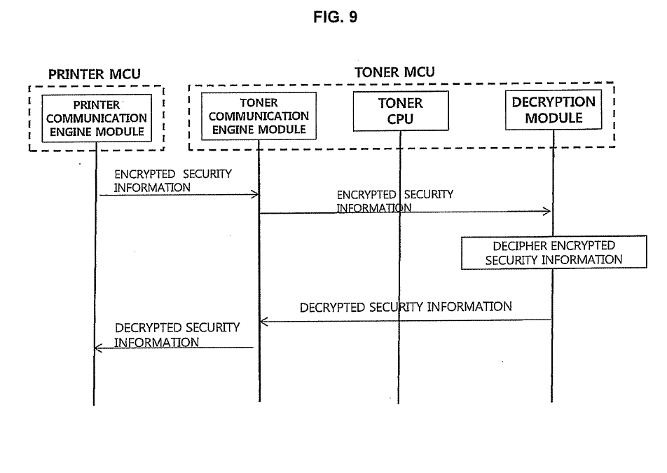

FIG. 9 is a flowchart showing the proposed processing flow of security information between printer MCU and toner MCU. Hereafter, for the convenience of description, only printer communication engine module is drawn in printer MCU and toner communication engine module, decryption module and toner CPU are drawn in toner MCU. Data communication between only functional modules shown in FIG. 9 will be described. Printer communication engine module transmits encrypted security information to toner communication engine module. And toner communication engine module transmits encrypted security information to decryption module. Decryption module deciphers encrypted security information into decrypted security information using one of plural toner security algorithm and transmits decrypted security information to toner communication engine module. Finally, decrypted security information is transmitted to printer MCU.

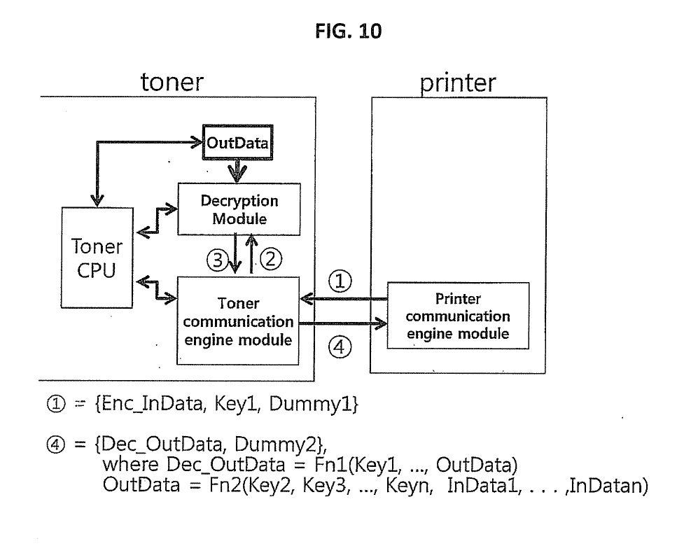

FIG. 10 is a diagram showing the proposed processing flow of security information between printer MCU and toner MCU in FIG. 9 in terms of system configuration. Processing flow in FIG. 10 is almost same to the processing flow in FIG. 9 and detailed description will be omitted. The necessary part will be described in FIG. 10.
\textcircled{1}={Enc_InData, Key1, Dummy1}
\textcircled{4}={Dec_OutData, Dummy2}, where Dec_OutData=Fn1(Key1, . . . , OutData) OutData=Fn2(Key2, Key3, . . . , Keyn, InData1, . . . , InDatan)
Enc_InData: encrypted input data inputted from printer to toner.
Key1: represent the first key among encryption keys. It also implies distinction with other keys like Key2, Key3 . . . etc.
Dummy1: dummy data. It can be general data.
Dec_OutData: decrypted output data outputted from toner
Dummy2: dummy data. It can be general data.
Fn1: first function
OutData: OutData are made to fit in the format of defined by the rules between printer and toner. Configuration of OutData is the form of the following expression:

OutData=Fn2(Key2, Key3, . . . , Keyn, InDatat1, . . . , InDatan)
Fn2: second function
Key2: represent the second key among encryption keys. It also implies distinction with other keys like Key1, Key3 . . . etc.
Key3: represent the third key among encryption keys. It also implies distinction with other keys like Key1, Key2, Key4 . . . etc.
Keyn: represent nth key among encryption keys. It also implies distinction with other keys like Key1, Key2, . . . , Keym, . . . , etc.
InData1: represent the first input data among plural input data. It also implies distinction with other input data like InData2, InData3 . . . etc.

InDatan: represent nth input data among plural input data. It also implies distinction with other input data like InData1, InData2 . . . InDatam, . . . etc.

Although the preferred embodiments of the present invention have been described and illustrated using specific terms, and those terms are merely intended to definitely describe the present invention. The embodiments of the present invention and terms described therein can be modified and changed in various manners without departing from the scope and spirit of the invention as disclosed in the accompanying claims. The embodiments modified in this way should not be understood separately from the spirit and scope of the present invention, and should be defined by the accompanying claims of the present invention, and their equivalents.

What is claimed is:

1. A printer apparatus, the printer apparatus including a printer for encrypting and providing an externally received document using a printer security algorithm, and a toner cartridge for decrypting and providing the encrypted document using a toner security algorithm, wherein:
the printer comprises writable non-volatile memory for storing a plurality of printer security algorithms and storing a plurality of key values applicable to the respective printer security algorithms and an encryption module for encrypting the document using one selected from among the plurality of printer security algorithms and providing an encrypted document to the toner cartridge, and
the toner cartridge comprises writable non-volatile memory for storing a plurality of toner algorithms corresponding to the plurality of printer security algorithms and a plurality of key values applicable to the respective toner security algorithms, and a decryption module for decrypting the encrypted document using one selected from among the plurality of toner security algorithms.

2. The printer apparatus of claim 1, wherein the writable non-volatile memory of the printer comprises an algorithm storage unit for storing the selected one printer security algorithm as a printer security algorithm identifier required to distinguish the selected one printer security algorithm from other printer security algorithms, and a key value storage unit for storing key values currently being used in the printer.

3. The printer apparatus of claim 2, wherein the writable non-volatile memory of the toner cartridge comprises an algorithm storage unit for storing the selected one toner security algorithm as a toner security algorithm identifier required to distinguish the selected toner security algorithm from other toner security algorithms, and a key value storage unit for storing key values currently being used in the toner cartridge.

4. The printer apparatus of claim 2, wherein a printer security algorithm to be executed by the encryption module can be changed by changing the printer security algorithm identifier stored in the algorithm storage unit of the printer, and a toner security algorithm to be executed by the decryption module can be changed by changing the toner security algorithm identifier stored in the algorithm storage unit of the toner cartridge.

5. The printer apparatus of claim 1, wherein at least one of the plurality of printer security algorithms stored in the writable non-volatile memory of the printer is replaceable with a new printer security algorithm downloaded from an external device.

6. The printer apparatus of claim 1, wherein the printer further comprises a toner replacement check module for detecting replacement of the toner cartridge or re-booting of the printer.

7. The printer apparatus of claim 1, wherein the printer classifies toner cartridges mounted therein into at least two classes based on predetermined criteria, and stores the classified toner cartridge classes in the writable non-volatile memory.

8. The printer apparatus of claim 1, wherein the printer apparatus further comprises a toner communication engine module and a toner CPU connected between the toner communication engine module and the decryption module, and wherein the toner communication engine module receives a encrypted security information from the printer and transmits the encrypted security information to the decryption module without going through the operation process of the toner CPU and the decryption module deciphers the encrypted security information into a decrypted security information using one of the plurality of toner algorithms and transmits the decrypted security information to the toner communication engine module without going through the operation process of the toner CPU.

9. A security method applicable to a printer apparatus including a printer a printer for encrypting a received document and transmitting an encrypted document to a toner cartridge, and the toner cartridge for decrypting and printing the encrypted document, comprising:
a) storing a plurality of printer encryption algorithms and a plurality of key values applicable to the respective printer encryption algorithms, in the printer;
b) storing a plurality of toner encryption algorithms respectively corresponding to the plurality of printer encryption algorithms and a plurality of key values applicable to the respective toner encryption algorithms;
c) the printer selecting one from among the plurality of printer encryption algorithms; and
d) the printer transmitting information required to identify a toner encryption algorithm corresponding to the printer encryption algorithm selected at c) to the toner cartridge.

10. The security method of claim 9, further comprising after d):
e) the printer downloading a toner security algorithm corresponding to a new printer security algorithm from outside;
f) deleting one of the plurality of printer encryption algorithms and storing the new printer security algorithm; and
g) the printer transmitting a toner security algorithm corresponding to the new printer security algorithm to the toner cartridge.

11. The security method of claim 10, further comprising, after g), h) the toner cartridge deleting one of the plurality of toner encryption algorithms and storing a toner security algorithm corresponding to the new printer security algorithm.

12. A security method applied to a printer system, the printer system including a printer for encrypting a received document and transmitting an encrypted document to a toner cartridge, the toner cartridge for decrypting and printing the encrypted document, an internal computer for transmitting the document to the printer, and a management server connected to the internal computer over a communication network and configured to remotely control the printer, comprising:
a) determining whether the printer has been re-booted or a mounted toner cartridge has been replaced;
b) reading toner information including a manufacturer of the toner cartridge, a serial number of the toner cartridge, and a toner encryption algorithm used for decryption;
c) transmitting the toner information read from the toner cartridge to the management server;
d) the management server determining a class of the toner cartridge using the received toner information;
e) transmitting the determined toner cartridge class both to the printer and to the toner cartridge over the communication network; and
f) the printer and the toner cartridge individually storing the toner cartridge class.

13. The security method of claim 12, further comprising, after f), g) the internal computer determining toner usage policies required to determine whether the toner cartridge is usable depending on the toner cartridge class.
